(19) United States
(12) Patent Application Publication
(10) Pub. No.: US 2026/0100667 A1
(43) Pub. Date: Apr. 9, 2026

(54) SHEATHING, PRE-INSTALLED ANCHORS FOR MOUNTING SOLAR PANEL MODULES, AND METHOD OF INSTALLATION

(71) Applicant: Unirac, Inc., Albuquerque, NM (US)

(72) Inventor: Nicolas Martinez, Albuquerque, NM (US)

(21) Appl. No.: 19/347,359

(22) Filed: Oct. 1, 2025

Related U.S. Application Data
(60) Provisional application No. 63/702,749, filed on Oct. 3, 2024.

(51) Int. Cl. H02S 20/23

(52) U.S. Cl. CPC H02S 20/23

(57) ABSTRACT

A sheathing includes a plurality of anchors attached to the sheathing. The plurality of anchors are arranged in a predetermined pattern prior to installation of the sheathing onto a structure. At least a portion of the plurality of anchors are configured to receive a fastener that attaches a bracket to the structure for supporting solar panel modules.

### CROSS-REFERENCE TO RELATED APPLICATIONS

This application claims priority to U.S. Provisional Patent Application No. 63/702,749, filed October 3, 2024, entitled “Sheathing, Pre-Installed Anchors for Mounting Solar Panel Modules, and Method of Installation,” the entirety of which is herein incorporated by reference.

### BACKGROUND

Solar panel modules are typically secured to a surface, such as a roof, using a racking or mounting system. In some examples, the racking or mounting system is secured directly into rafters or trusses disposed beneath the surface. However, locating the rafters or trusses beneath the surface can be a tedious and time-consuming process. Although not required to be secured directly into the rafters or trusses, if secured into other layers of the surface, such as sheathing, fasteners may tend to back out or become loose over time. In such instances, the securement of the solar panel modules is compromised and/or the surface may be susceptible to leaks.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an example structure having sheathing with pre-installed anchors, according to examples of the present disclosure.

FIG. 2 illustrates an example configuration of the pre-installed anchors of FIG. 1, according to examples of the present disclosure.

FIG. 3 illustrates a first example of the pre-installed anchors of FIG. 1, according to examples of the present disclosure.

FIG. 4 illustrates a second example of the pre-installed anchors of FIG. 1, according to examples of the present disclosure.

FIG. 5 illustrates a third example of the pre-installed anchors of FIG. 1, according to examples of the present disclosure.

FIG. 6 illustrates a fourth example of the pre-installed anchors of FIG. 1, according to examples of the present disclosure.

FIG. 7 illustrates an example punch for determining locations of the pre-installed anchors of FIG. 1 beneath a roofing material, according to examples of the present disclosure.

FIG. 8 illustrates an example group of pre-installed anchors, according to examples of the present disclosure.

FIG. 9 illustrates an example process associated with pre-installing anchors, according to examples of the present disclosure.

### DETAILED DESCRIPTION

This application is directed, at least in part, to systems and methods of installing anchors into sheathing for accommodating solar panel modules, according to examples of the present disclosure. In an embodiment, the anchors may be installed into the sheathing at a factory and/or before installation of the sheathing onto a structure, such as a roof. In this manner, the anchors may be pre-installed on the sheathing. For example, at a work or job site, the anchors may be pre-installed into the sheathing before the sheathing is installed, hoisted, etc., onto the roof. In an embodiment, fasteners may be used to attach brackets and/or other mounts to the anchors, and in turn, the solar panel modules may be mounted to the brackets. The anchors may reduce the amount of time and/or complexities associated with installing the solar panel modules.

The anchors may represent any suitable fastener capable of being installed into, onto, etc., the sheathing. As non-limiting examples, the anchors may include toggle anchors, expanding anchors, wing nuts, rivet nuts, ribbed head anchors, wood inserts, threaded inserts, etc. When installed, the anchors may resist separation from the sheathing. The anchors may also effectively distribute loads across the sheathing. This is in comparison to conventional methods whereby fasteners that are used to install the solar panels to the roof tend to back out and/or strip corresponding portions of the sheathing.

In an embodiment, the anchors may be installed across the sheathing as an array, grid, pattern, etc. Moreover, any number of the anchors may be disposed across the sheathing, such as one, ten, thirty, etc. In an embodiment, a single anchor may be installed in a center of the sheathing. In an embodiment, the sheathing may come in 4’ x 8’ sheets, and the anchors may be installed across the sheathing in an array, grid, pattern, etc. The anchors may be installed in a predetermined pattern to permit their location to be determined after roofing materials are installed.

Any suitable techniques may be used to install the anchors into the sheathing, including drilling, press-fit, punching, fastening, etc. In an embodiment, the anchors themselves may be secured to the sheathing via adhesives, fasteners, and/or based on being press-fit into the sheathing (i.e., by the friction and pressure created by the sheathing as the anchor is disposed into a material of the sheathing). The sheathing may represent any suitable sheathing, such as plywood, OSB, cement board, gypsum, etc. Although described as being 4’ x 8’ in size, other sizes of the sheathing are envisioned (e.g., 4’ x 4’), and in an embodiment, the number, placement, etc., of the anchors may be based on the size, material, etc., of the sheathing. Moreover, although referred to herein as “sheathing,” the anchors may be pre-installed on, in, etc., other panels, sheets, plates, materials, etc.

In an embodiment, the anchors may be installed as groups of 2, 4, etc., arranged as a diamond or other pattern best suited for attaching the solar panel models, or a solar photovoltaic (pv) system, to the roof. In an embodiment, the brackets may be secured to the group of anchors to secure the brackets to the roof. Securing the brackets to the group, or more than one of the anchors, may distribute a load experienced by the anchors. In turn, this may prevent the anchors from backing out of the sheathing. As such, more than one fastener may secure the brackets to the sheathing, where the fasteners may be respectively attached to individual anchors.

Alternatively, in an embodiment, the anchors may be integrated within panels, plates, mounts, etc., installed on the sheathing. This may avoid having to individually install the anchors into the sheathing, but rather, the group of anchors may be installed via installing a plate that has multiple anchors. For example, a plate may include four anchors, which may receive four respective fasteners to secure individual brackets to the surface. The number of anchors disposed across the plate, or the location of the anchors on the plate, may be based on the brackets being installed. Any number of the plates may be disposed across the sheathing, and the plates may include more than or less than four of the anchors. In an embodiment, the plates may be installed into the sheathing via fasteners, adhesive, press-fit, etc. In an embodiment, the plates may assist in distributing a load across the sheathing. In an embodiment, the plate may be a galvanized steel plate with teeth on one side and a threaded aperture in the middle. The teeth may be embedded on an underside or top side of the sheathing to effectively distribute the load across the sheathing and secure the plate to the sheathing. During securement of the fasteners into the anchors on the plate, the plate may become further secured to the sheathing.

The anchors may be spaced apart from one another by a known or predetermined distance, such that after installation of a roof onto the sheathing, the anchors are locatable. For example, a roof (e.g., composite shingles, tiles, metal, etc.) may be installed on top of the sheathing, thereby visually concealing a location of the anchors. In an embodiment, the anchors may be equidistantly spaced apart from one another. In an embodiment, an entirety or a portion of the anchors is concealed via the roof. However, once one of the anchors is located, remaining locations of the other anchors may be known based on the predetermined spacing between the anchors and/or a layout of the anchors. The spacing or locations of the anchors may be based on the solar panel modules configured to attach to the roof (e.g., size, weight, number, etc.), specifics of the roof itself (e.g., size), etc.

In an embodiment, the anchors may be located (i.e., beneath the roof) via magnetic elements, stencils, etc. For example, a device (e.g., tool, instrument, etc.) may include a magnetic element that magnetically attracts to the anchor. When disposed over the anchor, the device may output an indication such that the location of the anchor may be determined. The indication may be a light, audio, toggle connected to the magnetic element, etc. As another example, before (i.e., prior to) the roof is installed across an entirety of the sheathing, a location of an exposed anchor may be used to locate a remaining portion of the anchors. For example, given that the anchors may be disposed across rows and columns, locating one of the anchors may be used to locate the remaining anchors. Stencils and/or templates may also be used to locate the anchors. As another example, the anchors may include punches that puncture, pierce, indent, deform, etc., a portion of the roof disposed above the anchor. The location at which the punch punctures or penetrates through the roof may indicate a location of the anchor. In an embodiment, the punches may be integrated within the anchors or may be a separate component from the anchors.

As introduced above, fasteners may be used to attach brackets to the roof. The anchors may include receptacles, threaded passageways, etc., into which the fasteners are disposable to secure the fasteners to the anchors. Correspondingly, since the anchors are attached to the sheathing, securing the fasteners to the anchors mounts the brackets to the roof. The brackets may be located on top of the roof, and the solar panel modules may connect to the brackets, whether directly or indirectly (e.g., via rails, mounts, etc.) via fasteners, snap-fits, etc.

In an embodiment, while the sheathing may include a plurality of anchors, not all of the anchors may be utilized to secure the brackets to the sheathing. For example, only a subset of the anchors may be used to attach the brackets to the sheathing. Additionally, although discussed herein as being used to attach brackets to the surface, in an embodiment, the solar panel modules may directly mount to the anchors via the fasteners, and/or other equipment, appliances, etc., may be mounted to the surface and attached to the sheathing via the anchors.

In an embodiment, different portions of the sheathing, or different types of sheathing, may have different densities of the anchors. For example, for heavier solar panel modules, brackets that are secured with an increased number of fasteners and/or sheathing with a greater density of the anchors may be used. In an embodiment, where a greater density of anchors are used, load distributing plates, connectors, etc., may be installed to distribute loads across the sheathing.

In an embodiment, sealants (flowable or non-flowable), flashing, washers, etc., may be disposed around the anchors to inhibit an ingress of liquid into the roof. For example, butyl may seal the anchor against the sheathing. The sealants may be installed during installation of the anchors into the sheathing to seal the anchors to the sheathing and/or sealant may be disposed between the fastener and the bracket during installation into the anchor.

Although discussed in relation to roof environments, in an embodiment, the systems and methods described herein may be applied to or find use in other environments. For example, anchors may be pre-installed in sheathing used for walls, floors, etc., where the anchors may be used to mount structures, fixtures, etc., to the walls, floors, etc. In an embodiment, the anchors may also find use in structural insulated panels (SIPs), where the anchors may be pre-installed on one or more of the panels that enclose an insulating foam core. The panels themselves may include different distributions, densities, etc., of the anchors depending upon the application, environment, use, etc.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment or instance may be combined with the features of other embodiments or instances. Such modifications and variations are intended to be included within the scope of the disclosure and appended claims.

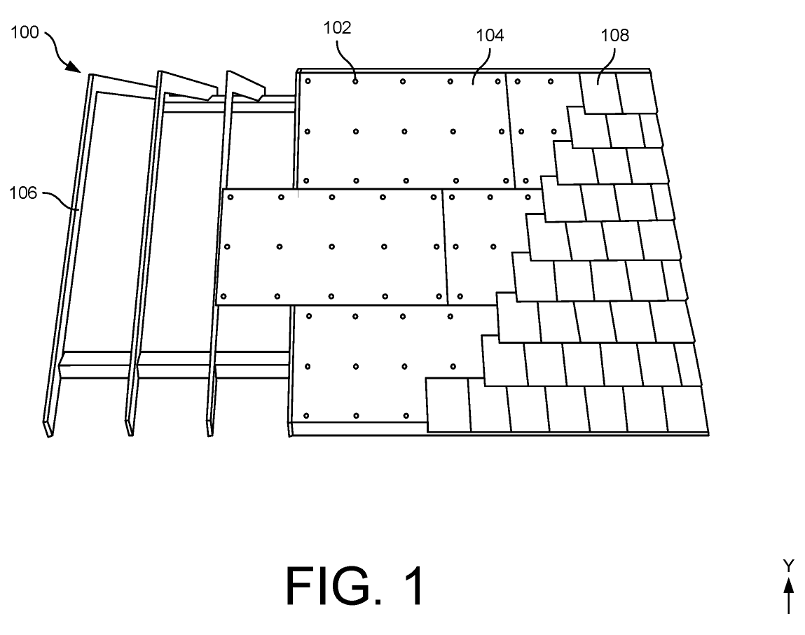

FIG. 1 illustrates an example structure 100 having anchors 102 pre-installed into sheathing 104, according to examples of the present disclosure. As shown, the structure 100, which may represent a roof, may include rafters 106 into which the sheathing 104 is secured (e.g., via nails, screws, etc.). The anchors 102 are disposed across the sheathing 104 as an array, grid, etc., for example, within columns and rows. As will be discussed herein, the anchors 102 may be used to secure solar panel modules to the structure 100. For example, after a roofing material 108, such as shingles, is secured to the sheathing 104, brackets may be attached to the structure 100 via securing fasteners into the anchors 102. Thus, the solar panel modules, whether directly or indirectly, may be mounted to the structure 100 via the brackets. Although the anchors 102 are shown and described as being installed into the sheathing 104, in an embodiment, the anchors 102 may be installed in the rafters 106. Moreover, in an embodiment, the anchors 102 may be aligned with the rafters 106 and/or may not be aligned with the rafters 106.

As used herein, the anchors 102 may be considered “pre-installed” whereby the anchors 102 are installed onto, into, etc., the sheathing 104 before the roofing material 108 is attached to the sheathing 104. For example, the anchors 102 may be installed at a factory, before arrival at a jobsite, at the jobsite but before being installed on the structure 100, and/or after being installed on the structure 100 but before the roofing material 108 is attached. In an embodiment, the anchors 102 may be installed at a factory to increase the production rate, reduce costs, and ensure dimensional accuracy and quality.

Although a certain arrangement of the anchors 102 is shown, other arrangements, configurations, etc., are envisioned. For example, a greater density of anchors may be disposed across the sheathing 104, the anchors 102 may be grouped together, etc. In an embodiment, the anchors 102 may be similar to or different than one another, for example, to receive differently sized fasteners.

The sheathing 104 may represent any suitable sheathing, such as plywood, OSB, cement board, gypsum, etc. Although shown as being applied to a roof structure, the sheathing 104 with the anchors 102 may be used on other surfaces, such as on walls, floors, ceilings, etc. In such instances, the sheathing 104 may include plywood, OSB, etc., or the sheathing 104 may represent other panels, sheets, plates, etc. Moreover, the sheathing 104, in an embodiment, may be combined or used in conjunction with other materials, such as in SIP. For example, the sheathing 104 with the anchors 102 may be one or more layers of a SIP.

The structure 100 may also include additional materials, such as ice block, tar paper, etc., in addition to the roofing material 108. In such instances, the fasteners that are secured into the anchors 102 may be secured through any number of layers that make up the structure 100. The roofing material 108 may include composite shingles, metal, tile, cedar planks, etc.

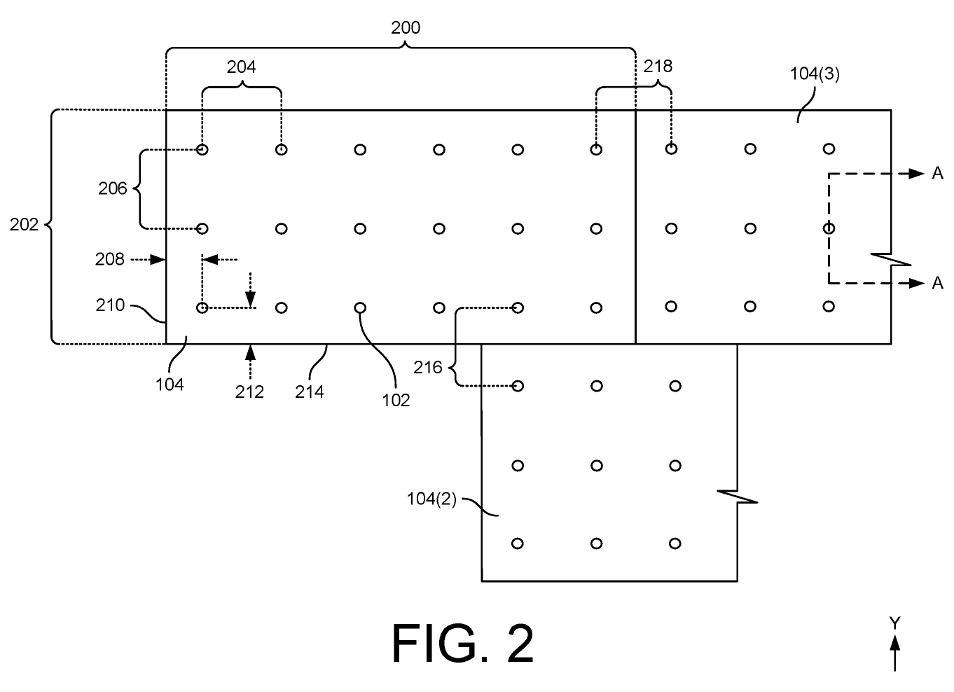

FIG. 2 illustrates the anchors 102 being pre-installed into the sheathing 104, according to examples of the present disclosure. The anchors 102 may be installed into the sheathing 104 as a preconfigured layout, grid, array, etc. For example, as shown, the sheathing 104 may include 18 of the anchors 102 arranged in 3 rows and six columns. Other arrangements of the anchors 102 are envisioned.

The sheathing 104 includes a length 200 (e.g., in the X-direction) and a width 202 (e.g., in the Y-direction). In an embodiment, the length 200 may be eight feet, while the width 202 may be four feet. Other dimensions of the sheathing 104 are envisioned and/or the sheathing 104 may be shaped differently than shown. In an embodiment, the arrangement of the anchors 102 may be based on the size, shape, etc., of the sheathing 104

The anchors 102 may be spaced apart from one another by known distances to permit the anchors 102 to be located after the roofing material 108 is installed. This permits the fasteners to be secured into the anchors 102. In an embodiment, the anchors 102 may be equidistantly spaced apart from one another. For example, the anchors 102 may be spaced apart by a first distance 204 along the length 200 of the sheathing 104 and may be spaced apart by a second distance 206 along the width 202 of the sheathing 104. In an embodiment, the first distance 204 and the second distance 206 may be the same. Moreover, the anchors 102 may be spaced apart by a third distance 208 from a first edge 210 (e.g., left side) and may be spaced apart by a fourth distance 212 from a second edge 214 (e.g., bottom). Although not shown, the anchors 102 may be spaced apart by the third distance 208 from a third edge (e.g., right side), opposite the first edge 210, and may be spaced apart by the fourth distance 212 from a fourth edge (e.g., top), opposite the second edge 214. The third distance 208 and the fourth distance 212 may be the same. Moreover, the third distance 208 and the fourth distance 212 may be half the first distance 204 and the second distance 206.

Given the spacing of the anchors 102, as the sheathing 104 attaches to the structure 100, end-to-end, top to bottom, etc., the anchors 102 may be spaced apart by known distances. For example, as a second piece of the sheathing 104(2) is attached below the sheathing 104, the anchors 102 may be spaced apart by a fifth distance 216 that is the same as the second distance 206. Additionally, as a third piece of the sheathing 104(3) is attached adjacent to the sheathing 104, the anchors 102 may be spaced apart by a sixth distance 218 that is the same as the second distance 206. Indications, markings, indents, etc., on the sheathing 104, the second piece of sheathing 104(2), and/or the third piece of sheathing 104(3) may be used to align the sheathing 104, the second piece of sheathing 104(2), and/or the third piece of sheathing 104(3) such that the anchors 102 are spaced apart appropriately between piece of sheathing 104. This permits the anchors 102 to be easily locatable across sheets of the sheathing 104.

For example, in an embodiment, once the roofing material 108 is deposited on top of the sheathing 104, a stencil or other instrument may be used to locate the anchors 102. Moreover, given that the anchors 102 may be spaced apart from one another by known distances, locating one of the anchors 102 may be used to locate other of the anchors 102 on the sheathing 104.

Although shown as including a particular number of the anchors 102, the sheathing 104 may include more than or less than the number of the anchors 102 as shown and/or the anchors 102 may be arranged differently than shown. For example, the anchors 102 may be arranged in a greater or lesser number of rows and/or columns. In an embodiment, different portions, areas, sections, etc., of the sheathing 104 may have different densities, sizes, patterns, etc., of the anchors 102. For example, where the brackets are configured to attach to the sheathing 104, a greater density of the anchors 102 may be used. Comparatively, for portions of the sheathing 104 where rails attach, a lesser density of the anchors 102 may be used.

As an example, although individual anchors of the anchors 102 are shown being spaced apart by the first distance 204 and the second distance 206, groups of the anchors 102 may be spaced apart by the first distance 204 and/or the second distance 206. For example, more than one fastener may be used to secure the brackets to the sheathing 104. In such instances, more than one of the anchors 102 may be grouped together to receive respective fasteners for securing the brackets to the sheathing 104.

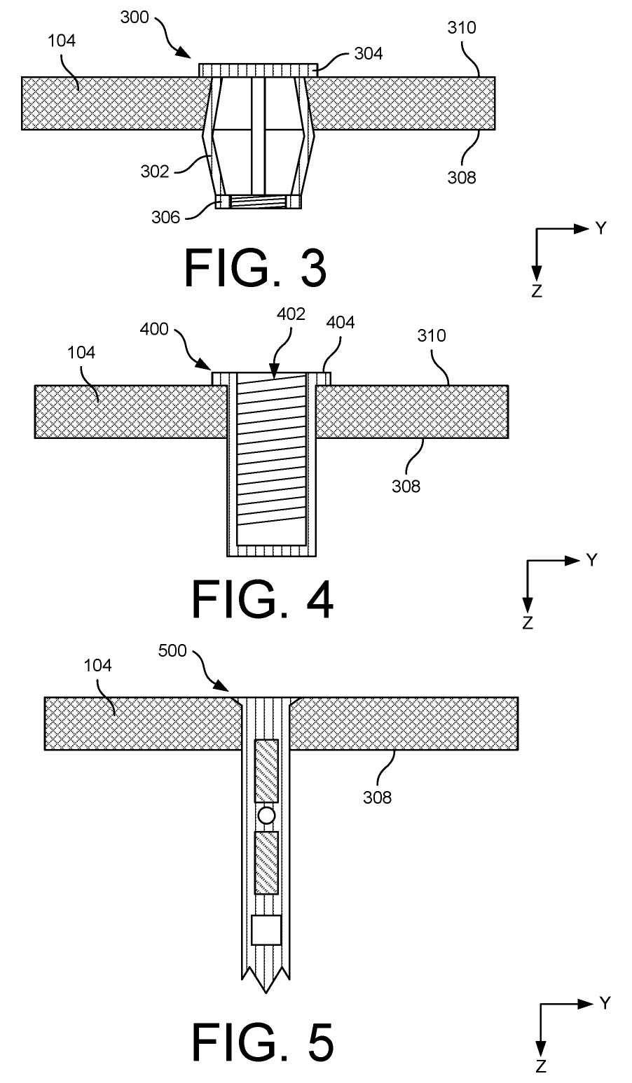

FIG. 3 illustrates an example anchor 300 attached to the sheathing 104, taken along line A—A of FIG. 2, for example, according to examples of the present disclosure. The anchor 300 may include one or more arms 302 that are disposed between a top portion 304 and a bottom portion 306. The fastener may be threaded into the bottom portion 306 (e.g., a receptacle in the bottom portion 306). When driven, the arms 302 may compress against a bottom surface 308 of the sheathing 104, thereby securing the anchor 300 to the sheathing 104. The arms 302, when compressed against the bottom surface 308, prevent removal of the anchor 300 through a hole disposed in the sheathing 104.

As shown, the top portion 304 may be disposed adjacent to a top surface 310. In an embodiment, the top portion 304 may be disposed above the top surface 310 or may be inset within the top surface 310 (e.g., via a counterbore). For example, the top surface 310 may have a counterbore in which a head of the anchor 300 is disposed.

FIG. 4 illustrates an example anchor 400 attached to the sheathing 104, taken along line A—A of FIG. 2, for example, according to examples of the present disclosure. The anchor 400 may include a receptacle 402 into which the fastener is threaded. In an embodiment, the anchor 400 may represent a rivet nut that is press-fit into a hole in the sheathing 104. Alternatively, the anchor 400 may be self-tapping and threaded into the sheathing 104. In an embodiment, an end of the receptacle 402 may be enclosed to prevent an ingress of liquid into the surface.

In an embodiment, a head 404 of the anchor 400 is disposed about the top surface 310 of the sheathing 104, or the head 404 may be inset within the top surface 310. In an embodiment, the head 404 may include spikes, ribs, etc., that engage with the top surface 310 to secure the anchor 400 to the sheathing 104.

Although shown as being disposed into/through the top surface 310, in an embodiment, the anchor 400 may be disposed into/through the bottom surface 308. In such instances, an end of the anchor 400 may be open to receive the fastener adjacent to the top surface 310 and the head 404 is disposed adjacent to the bottom surface 308. When the fastener is fastened into the anchor 400, the head 404 may engage with the bottom surface 308.

FIG. 5 illustrates an example anchor 500 attached to the sheathing 104, taken along line A—A of FIG. 2, for example, according to examples of the present disclosure. In an embodiment, the anchor 500 may represent a self-tapping toggle bolt. As the fastener is disposed within the anchor 500, arms of the anchor 500 may rotate, translate, etc., to engage the bottom surface 308. This prevents a disengagement between the anchor 500 and the sheathing 104, and/or prevents the anchor 500 from being pulled through a hole in the sheathing 104.

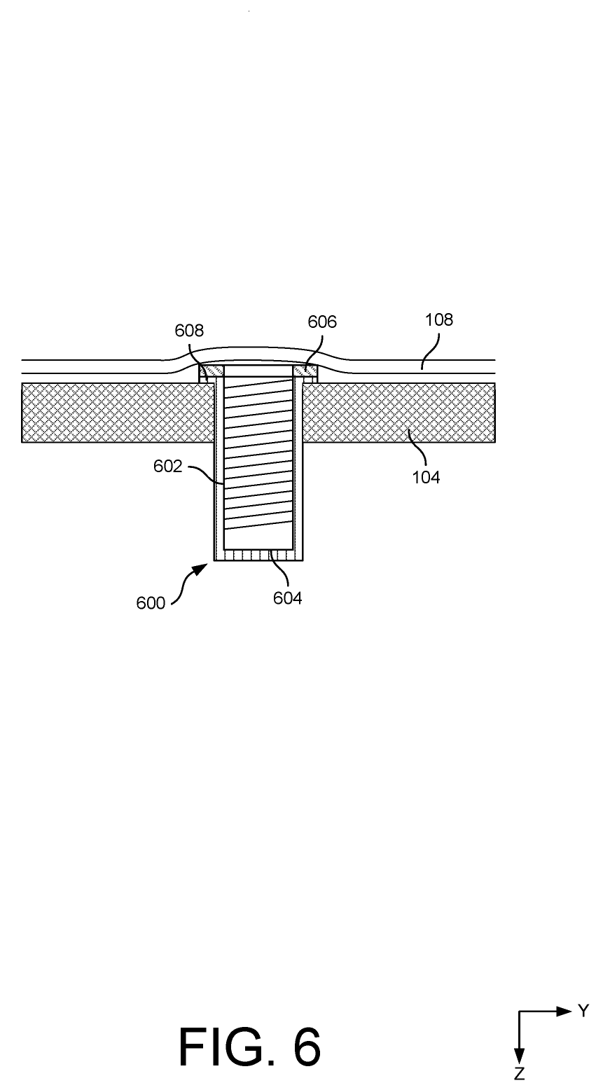

FIG. 6 illustrates an example anchor 600 attached to the sheathing 104, taken along line A—A of FIG. 2, for example, according to examples of the present disclosure. In FIG. 6, the anchor 600 is shown disposed within the sheathing 104. The anchor 600 may include a threaded passage 602 into which a fastener is disposed for securing a bracket to the structure 100. The threaded passage 602 may represent a “blind hole” in which a bottom 604 of the threaded passage 602 is enclosed. The enclosed nature of the bottom 604 may prevent liquid from permeating into the structure 100. For example, if any liquid enters the threaded passage 602, the enclosed nature of the bottom 604 may prevent the liquid from permeating into the structure 100.

A seal 606 may be disposed adjacent to a flange 608 (or head) of the anchor 600. As shown, the seal 606 may be disposed between the flange 608 and the roofing material 108. The seal 606 may be manufactured from EPDM (or similar material, such as rubber, silicone, etc.) that is adhered to the flange 608. In an embodiment, the seal 606 may be located beneath the flange 608. The seal 606 may be representative of a washer, gasket, etc. In an embodiment, the seal 606 may be pre-formed or pre-cut (e.g., from butyl, rubber, etc.), or the seal 606 may be formed via depositing a liquid sealant (e.g., flowable sealant around the flange 608).

The seal 606 may seal (e.g., adhere) against roofing material 108 and the anchor 600 to prevent ingress of liquid into the structure 100 and/or to the sheathing 104. As indicated above, any liquid that may permeate through the roofing material 108 (at a location at which the fastener is disposed through the roofing material 108 and into the threaded passage 602) may be prevented from flowing onto the sheathing 104 via the seal 606. Instead, any liquid may flow into the threaded passage 602.

Although FIGS. 3-6 illustrate particular anchors, other anchors may be secured to, embedded in, etc., the sheathing 104. The anchors may be secured to the sheathing 104 via being press-fit into the sheathing 104, fastened into the sheathing 104 (e.g., self-tapping), adhered to the sheathing 104, etc. Regardless of their specific embodiment, the anchors may include a receptacle to receive the fastener. In an embodiment, when the fastener is threaded into and/or received by the anchor, the anchor may become further secured to the sheathing 104. The anchors may also be sufficiently engaged with the sheathing 104 to resist rotation of the anchors (i.e., within the sheathing 104) when the fastener is threaded into the anchors. The anchors may be manufactured from metal, plastics, composites, and/or any combination thereof.

In an embodiment, the anchors include a first end disposed adjacent to the top surface 310 and a second end disposed adjacent to the bottom surface 308. In an embodiment, the second end may be disposed past the bottom surface 308 (e.g., in the Z-direction), so as to protrude through or beyond the bottom surface 308. However, in an embodiment, the second end may be flush or inset within the bottom surface 308. As discussed hereinabove, the first end may be flush with the top surface 310 or may be inset within the top surface 310.

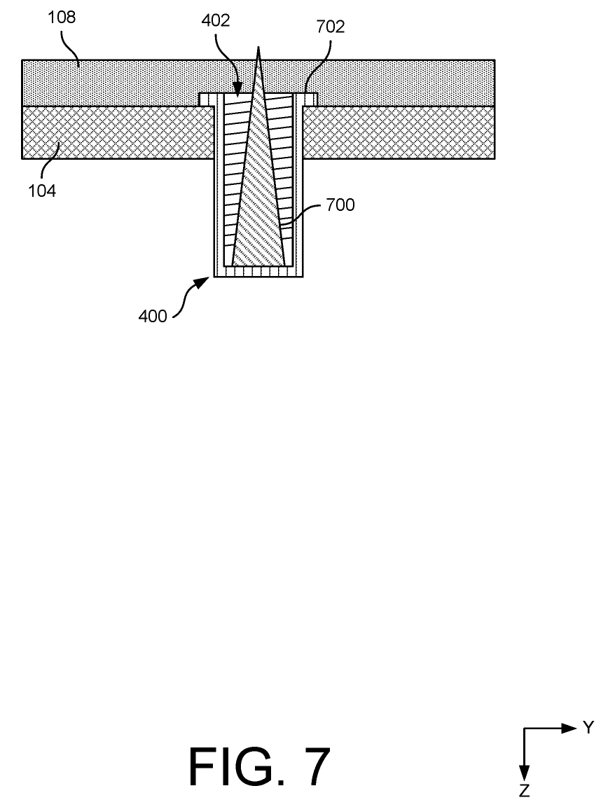

FIG. 7 illustrates an example punch 700 that may be used in association with the anchor 400, according to examples of the present disclosure. The punch 700 may be disposed in the receptacle 402 of the anchor 400 before the roofing material 108 is attached to the sheathing 104. The punch 700 may puncture, pierce, indent, deform, etc., a portion of the roofing material 108 disposed above the anchor 400. The location at which the punch 700 punctures through the roofing material 108 may indicate a location of the anchor 400.

In an embodiment, the punch 700 may be integrated with the anchor 400, for example, on a top flange 702 of the anchor 400. In an embodiment, the punch 700 may engage (e.g., press-fit, fastened, etc.) with the anchor 400. The engagement between the punch 700 and the anchor 400 may prevent reorientation of the punch 700 as the roofing material 108 is installed on top of or over the sheathing 104 and/or over the anchor 400. Regardless of the specific embodiment, the punch 700 may indicate a location of the anchor 400, or the receptacle 402, beneath the roofing material 108. Additionally, although described herein as being used with the anchor 400, the punch 700 may be used with other anchors. In such instances, the punch 700 may be modified to accommodate different anchors.

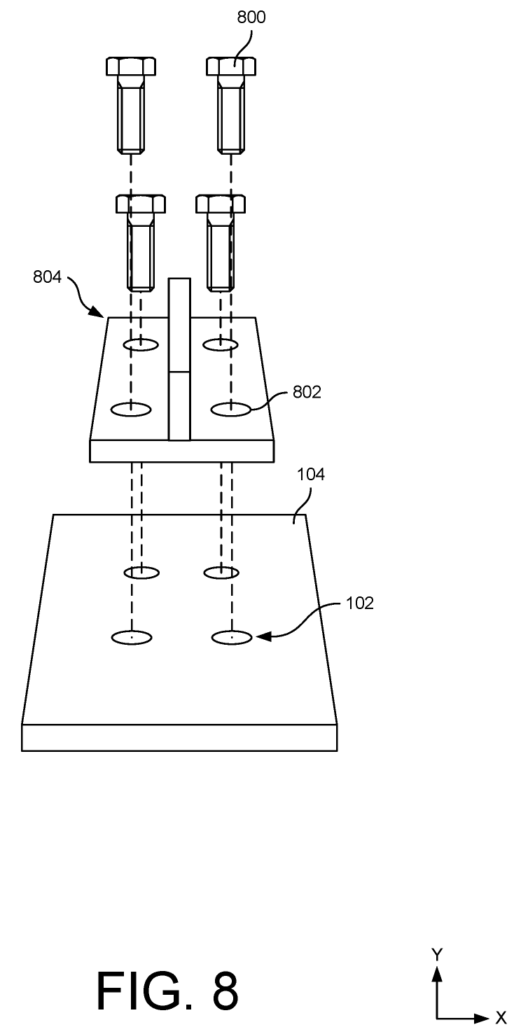

FIG. 8 illustrates example fasteners 800 that are used to connect a bracket 804 to the anchors 102, according to examples of the present disclosure. As discussed above, the anchors 102 may be disposed in the sheathing 104, below the roofing material 108, etc., and the fasteners 800 may be disposed through holes 802 in the bracket 804. As shown, four of the anchors 102 may be disposed in the sheathing 104, where respective fasteners of the fasteners 800 may be secured into respective anchors of the anchors 102. The anchors 102 may be disposed adjacent to one another, as a group, cluster, etc., to receive four of the fasteners 800. Although four of the anchors 102 are shown, a lesser or greater number of the anchors 102 may be grouped together. The number of the anchors 102 may be based on the bracket 804, and the anchors 102 may be installed on the sheathing 104 based on specifics of the bracket 804. Although shown as only including one of the brackets 804, more than one of the brackets 804 may be installed to support any number of solar panel modules.

After the brackets 804 are installed, the solar panel modules may be attached to the bracket 804 directly or indirectly via other mounts, brackets, etc. In an embodiment, only a portion of the anchors 102 within the group of the anchors 102 may be used to secure the bracket 804 to the sheathing 104 to account for different orientations of the bracket 804. For example, a group may include six or eight of the anchors 102 to account for different orientations of the bracket 804, and depending upon an orientation of the bracket 804 (N-S, E-W, etc.), only a subset of the anchors 102 in the group may be used to secure the bracket 804 to the sheathing 104.

In an embodiment, after locating the anchors 102, at least a portion of the roofing material 108 disposed around the anchors 102 may be removed, uncovered, etc. In such instances, to seal the sheathing 104 around the exposed area, a gasket or seal may be disposed around the anchors 102. As the bracket 804 is secured against the roofing material 108, the gasket or seal may prevent an ingress of liquid into the structure. In an embodiment, the gasket or seal may represent a flowable sealant (e.g., liquid butyl) or a non-flowable sealant (e.g., butyl tape).

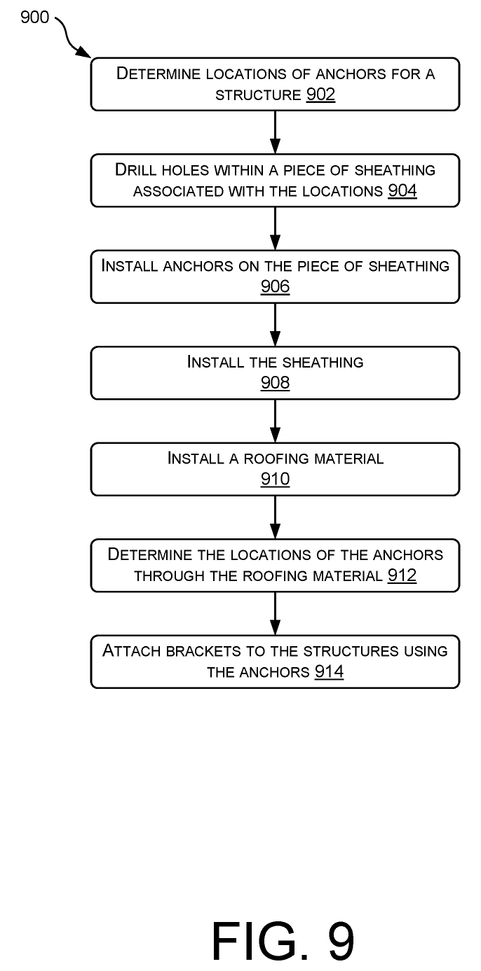

FIG. 9 illustrates an example process for installing the anchors 102 on the sheathing 104, according to examples of the present disclosure.

At 902, the process 900 may include determining locations of anchors for a structure. In an embodiment, the location of the anchors may be based at least in part on the structure, solar panel modules configured to be attached to the structure, brackets that secure the solar panel modules to the structure, etc. In an embodiment, the locations of the anchors may be based on a preconfigured layout, grid, array, etc.

At 904, the process 900 may include drilling holes within a piece of sheathing associated with the locations. For example, using the locations of the anchors 102, holes may be drilled into, punched through, etc., the sheathing 104. In an embodiment, the holes may be pilot holes to receive the anchors 102. However, in an embodiment, the holes may not be drilled, and the anchors 102 may be self-tapping, press-fit, etc., into the sheathing 104.

At 906, the process 900 may include installing the anchors on the piece of sheathing. For example, the anchors 102 may be attached to the sheathing 104 via press-fit, compression-fit, adhesives, fasteners, etc. In an embodiment, the anchors 102 may be installed within all of the holes or a portion of the holes. In an embodiment where the anchors are disposed across a plate, for example, the plate may be installed on the sheathing 104.

At 908, the process 900 may include installing the sheathing. For example, using nails, fasteners, etc., the sheathing 104 may be installed into the rafters 106. In an embodiment, the sheathing 104 may be installed according to a particular layout/pattern such that the anchors 102 are spaced apart by predetermined distances from one another to permit locating the anchors 102 after the roofing material 108 is installed.

At 910, the process 900 may include installing a roofing material. For example, using nails, fasteners, etc., the roofing material 108 may be attached to the sheathing 104. In an embodiment, other layers (e.g., ice block, tar paper, etc.) may be installed between the roofing material 108 and the sheathing 104. In an embodiment, the roofing material 108 may be disposed over an entirety of the sheathing 104, or less than an entirety of the sheathing 104 (e.g., to permit at least one of the anchors 102 to be located).

At 912, the process 900 may include determining the locations of the anchors through the roofing material. For example, using a magnetic element, stencil, the punch 700, etc., the locations of the anchors 102 may be determined. Once the location of one of the anchors 102 is determined, remaining locations of the anchors 102 may be deduced using the predetermined spacing between the anchors 102.

At 914, the process 900 may include attaching brackets to the structure using the anchors. For example, fasteners may be used to secure the brackets to the structure, whereby the fasteners are secured into the anchors 102.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

WHAT IS CLAIMED IS:

1. A sheathing comprising:
a plurality of anchors attached to the sheathing, the plurality of anchors being arranged in a predetermined pattern prior to installation of the sheathing onto a structure,
wherein at least a portion of the plurality of anchors are configured to receive a fastener that attaches a bracket to the structure for supporting solar panel modules.

2. The sheathing of claim 1, wherein the plurality of anchors are at least one of adhered, press-fit, or fastened to the sheathing.

3. The sheathing of claim 1, wherein:
the sheathing includes:
a top surface, and
a bottom surface opposite the top surface;
the plurality of anchors include:
a first end disposed adjacent to the top surface, and
a second end disposed adjacent to the bottom surface; and
the at least the portion of the plurality of anchors that are configured to receive the fastener are secured against the bottom surface.

4. The sheathing of claim 1, wherein the at least the portion of the plurality of anchors is arranged in a group based at least in part on the bracket.

5. The sheathing of claim 1, further comprising a seal disposed between the plurality of anchors and the sheathing.

6. The sheathing of claim 1, wherein the at least the portion of the plurality of anchors include a punch configured to deform, indent, or at least partially pierce one or more layers disposed adjacent to the sheathing.

7. A panel comprising:
a first end;
a second end opposite the first end;
a first side;
a second side opposite the first side; and
a plurality of pre-installed anchors in the panel,
wherein a fastener is disposable within individual anchors of the plurality of pre-installed anchors to attach a bracket to the panel for supporting one or more solar panel modules, and
wherein at least a portion of the plurality of pre-installed anchors are equidistantly spaced apart from one another (i) in a first direction between the first end and the second end, or (ii) in a second direction between the first side and the second side.

8. The panel of claim 7, wherein the plurality of pre-installed anchors is arranged in a predetermined pattern prior to installation of the panel onto a structure.

9. The panel of claim 7, wherein a location of the plurality of pre-installed anchors is based at least in part on the bracket.

10. The panel of claim 7, wherein one or more roofing materials are disposed at least partially over the plurality of pre-installed anchors prior to attaching the bracket to the panel.

11. The panel of claim 10, wherein the at least the portion of the plurality of pre-installed anchors include a punch to deform, indent, or at least partially pierce the one or more roofing materials to indicate a location of at least one pre-installed anchor of the at least the portion of the plurality of pre-installed anchors.

12. The panel of claim 10, further comprising a seal disposed between the plurality of pre-installed anchors and the panel.

13. The panel of claim 7, wherein:
individual pre-installed anchors of the plurality of pre-installed anchors include:
a first end, and
a second end;
the first end is open to receive the fastener; and
the second end is enclosed.

14. The panel of claim 7, wherein the plurality of pre-installed anchors is at least one of adhered, press-fit, or fastened to the panel.

15. The panel of claim 7, wherein the plurality of pre-installed anchors are self-tapping anchors to secure to the panel.

16. A method comprising:
determining locations to install a plurality of anchors into a piece of sheathing;
installing the plurality of anchors into the piece of sheathing at the locations, respectively;
installing the piece of sheathing onto a structure;
installing a roofing material onto the sheathing;
determining a location of the locations of one or more anchors of the plurality of anchors beneath the roofing material; and
attaching a bracket to the structure via fasteners secured into the one or more anchors.

17. The method of claim 16, wherein determining the location of the one or more anchors is based at least in part on the one or more anchors indenting, piercing, or deforming the roofing material.

18. The method of claim 16, further comprising installing a second piece of sheathing onto the structure, wherein the second piece of sheathing has a second plurality of anchors.

19. The method of claim 16, further comprising attaching at least one of a solar panel module or a rail that supports the solar panel module to the bracket.

20. The method of claim 16, further comprising disposing a seal around the plurality of anchors.
